(19) United States
(12) Patent Application Publication
(10) Pub. No.: US 2025/0022449 A1
(43) Pub. Date: Jan. 16, 2025

(54) Device for Mounting and Positioning an Electromechanical Transducer in a Stringed Instrument

(71) Applicant: Jason Sagall, Columbus, OH (US)

(72) Inventor: Jason Sagall, Columbus, OH (US)

(21) Appl. No.: 18/353,080

(22) Filed: Jul. 16, 2023

(51) Int. Cl. G10H 3/18

(52) U.S. Cl. CPC G10H 3/181

(57) ABSTRACT

A mounting device configurable to hold a plurality of pickups in a stringed instrument noninvasively and with minimal vibration. Provided is a means of readily repositioning the pickups vertically, linearly, and radially, resulting in an abundance of immediate tonal options. Further provided is a means of readily adjusting a positional tension to achieve a preferred friction for slanting, sliding, or securing each pickup into position.

### TECHNICAL FIELD

The present invention relates to stringed instruments comprising electromechanical transducers—i.e., pickups. A pickup proximate to strings of an instrument picks up tone-producing vibrations of the strings and thereby generates electrical signals for output to signal-manipulating processors, amplifiers, computers, etc. The present invention relates particularly to methods of adjustably mounting pickups in stringed instruments.

### BACKGROUND

The following is related prior art:

U.S. Patents

| Patent Number | Kind Code | Issue Date | Patentee |
|---|---|---|---|
| 11195503 | B2 | 2021 Dec. 7 | Bruen |
| 9401134 | B2 | 2016 Jul. 26 | Baker |
| 3911777 | | 1975 Oct. 14 | Rendell |

U.S Patent Application Publications

| Publication Nr. | Kind Code | Pub. Date | Applicant |
|---|---|---|---|
| 202104074866 | A1 | 2021 Dec. 30 | Baker |
| 20090249946 | A1 | 2009 Oct. 8 | Hunter |

Foreign Patent Documents

| Foreign Doc. Nr. | Cntry Code | Kind Code | Pub. Date | Patentee |
|---|---|---|---|---|
| 4019360 | DE | C2 | 1994 Oct. 20 | Liebchen |

### Non-Patent Literature Documents

Instrument: Framus 5/130 Hollywood
Ref.: https://www.grantsemporium.com/listing/717284029/framus-hollywood-electra-1962
Instrument: Dan Armstrong London
Ref.: http://www.danarmstrong.org/londonguitar.html
Instrument: Warwick Guy Pratt Signature
Ref.: https://www.youtube.com/watch?v=MS02YaLw1 uM
Instrument: Fodera Mike Pope Signature Viceroy
Ref.: https://fodera.com/products/mike-pope-signature-viceroy-6-bolt-on
Instrument: Gibson Grabber
Ref.: https://www.flyguitars.com/gibson/bass/grabber_techinfo.php

The quest for tone is universal among stringed instrument players. That is, to find an instrument having a particular tone character is paramount to the achievement of ultimate musical expression. And players will search relentlessly for—and hopefully attain—an instrument that produces the magical tone quality they hear in their heads.

Often times, a player will find an instrument that may not sound right in terms of tone but feels right in terms of functional playability, according to the player's individual preferences. Playability is determined by such factors as weight, balance, resonance, build quality, body shape, neck shape, bridge type, scale length.

Thus a practical approach to having an ideal instrument in both tone quality and playability is for a player to start with an instrument possessing the basic structural features and dimensions preferred by the player and then make changes to the basic means of capturing, shaping, and outputting the tones generated by the vibrating strings of the instrument.

Which brings us to pickups. In the category of stringed instruments that utilize pickups, including but not limited to electric guitars and basses, pickups are at the heart of tone shaping. A pickup's materials and electronic specifications—as well as its position relative to the strings of an instrument—have a substantial impact on the tone character of the output signal produced when the instrument is played and the signal amplified.

A pickup originally attached in a stringed instrument, e.g., by the manufacturer of the instrument, could be easily interchanged with a different pickup having different materials and specifications, and thus different tone-producing characteristics, provided: 1) the dimensions of the original pickup and that of the different pickup are about equivalent; and 2) the means of attaching the original pickup and that of the different pickup are about equivalent.

Hence pickup manufacturers in the field follow industry standards for the dimensions of their pickups and the attachment methods thereof. And stringed instrument manufacturers follow industry standards for the dimensions of the pickup cavities they rout into the bodies of their instruments.

So it is known and commonly practiced in the field to replace pickups in a stringed instrument that is off-the-rack with other pickups that are off-the-shelf.

Also known and commonly practiced in the field is to mass-produce stringed instruments having one pickup or a plurality of pickups configured as follows (by reference to an instrument resting horizontally, with the strings facing upward):
1) Adjustable vertically, i.e., movable relative to the space between the top of the pickup (or its pole pieces) and the string above it; and
2) Fixed linearly, i.e., stationary relative to a predetermined position along the length of the strings of the instrument; and
3) Fixed radially, i.e., stationary relative to a predetermined position around a vertical axis through about the center or an end of the pickup.

While stringed instruments having a plurality of pickups fixedly attached linearly provide some tonal variations (typically via an attached electronic switch allowing the player to select one or more pickups), the fixed attachment of the pickups limits the tonal options readily available. There is a need to free the pickups linearly and radially so that the player may readily explore and take advantage of tonal variations not afforded by the fixed attachment.

A few relevant stringed instrument models having at least one linearly adjustable pickup were manufactured and commercially marketed at one time or another:
(A) Framus 5/130 Hollywood Electra guitar (circa 1960)
(B) Framus 5/148 Hollywood Star bass (circa 1960)
(C) Dan Armstrong London guitar (circa 1970)
(D) Dan Armstrong London bass (circa 1970)
(E) Warwick Guy Pratt Custom Shop bass (circa 2014)
(F) Fodera Mike Pope Signature Viceroy bass (current as of 2023)
(G) Gibson Grabber bass (circa 1975)

The Framus models (A, B), the Armstrong models (C, D), the Warwick model (E), and the Fodera model (F) each comprises some means of sliding a pickup linearly via a single, center track under the pickup. All said models (A-F) further comprise some mechanism to adjustably attach the pickup to the track.

The track of the Framus models (A, B) and the Armstrong models (C, D) comprises: 1) a slot disposed along a length of the track; 2) a plate sized wider than the slot and disposed below the slot; and 3) a means of attaching the pickup to the plate via the slot; whereby the pickup attachably moves along the length of the track.

The Framus models (A, B) do not provide a means of readily adjusting a position of the pickup vertically or radially. The Framus models (A, B) do not provide the user with a means of readily adjusting a positioning tension—i.e., to secure a current position of the pickup or a preferred friction level when sliding the pickup linearly.

The track of the Armstrong models (C, D), being disposed above the top surface of the body of the instrument, necessitates a custom pickup of low profile sized and disposed within the space between the top of the track and the bottom of the strings. Thus the track of the Armstrong models (C, D) is not compatible with a wide range of standard, off-the-shelf pickups, which are substantially taller. Further, the Armstrong models (C, D) do not provide a means of readily adjusting a pickup vertically or radially. Nor do these models provide the user with a means of readily adjusting a positioning tension of the pickup.

The Warwick model (E) and the Fodera model (F) each comprises: 1) a rail attached directly to the body of the respective instrument; and 2) a carriage fixedly attached to the pickup and movably attached to the rail.

In the Warwick model (E), the dimensions of the rail and carriage necessitate an instrument having both a body and cavity of substantially great depth to house the massive mechanism under the pickup. The carriage, disposed fully around the rail, necessitates two raised attachment points in the body, one at each end of the rail, to attach the rail via screws into the body and suspend the rail in the cavity, thereby allowing clearance for the carriage.

The Fodera model (F) is similar to the Warwick model (E), however configured for much less linear travel distance of the pickup. Nonetheless, the rail and carriage of the Fodera model (F) necessitate a cavity in the body of the instrument substantially deeper than the height of the attached pickup. Further, the system requires mounting via screws into the body and coupling to the bottom of the pickup.

The Warwick model (E) and the Fodera model (F) do not provide a means of readily adjusting a position of the pickup radially or a means of readily adjusting a positioning tension of the pickup.

The Gibson model (G) appears to be an embodiment of U.S. Pat. No. 3,911,777 (1975) to Rendell. A sliding member is trapped between the body and the pickguard and slides horizontally. Hence the body must be sized and disposed to be a direct surface included in the means of sliding the one pickup. The horizontal length of the sliding member between the bridge and neck of the guitar reduces the linear positional range of the pickup. Like the models above. The Gibson model (G) does not provide a means of readily adjusting a position of the pickup radially or a means of readily adjusting a positioning tension of the pickup.

Other relevant patent materials relating to adjustably mounting a pickup in a stringed instrument disclose means that may be generally categorized as either track-and-carriage methods or slot-and-screw methods.

Falling generally within the track-and-carriage methods are the commercial models A-F (above) and U.S. Pat. No. 11,195,503 to Bruen. Such methods suffer from the substantial vertical size of the mechanism, configured substantially, if not entirely, below the pickup. That is, the mechanism will not comport with instruments off-the-rack (i.e., having no such mechanism) or at least some types of conventional pickups—e.g., humbuckers having mounting legs—as the pickup cavity in the body of off-the-rack instruments will typically have a depth commensurate with the height of the pickup disposed within the cavity and thus insufficient space for a track and carriage.

In real-world cases, the track-and-carriage methods necessitate a custom-built instrument having either: a) a body cavity deeper than that provided in typical off-the-rack instruments; or b) an unconventional, low-profile pickup having reduced vertical displacement, or c) a combination of (a) and (b).

Falling generally within the slot-and-screw methods is German patent DE4019360C2 (1994) to Liebchen, U.S. patent application publication US2009/0249946A1 (2009) to Hunter, U.S. Pat. No. 9,401,134 B2 (2016) to Baker, and U.S. patent application publication US2021/0407486A1 (2021) also to Baker. Such methods claim to move a pickup linearly via screws disposed vertically through a slot in a frame that is surface-mounted horizontally to a top or bottom of the body of the instrument, then through a springs, then through a hole in tapped and threaded ends of the pickup, thereby attaching the pickup by essentially conventional means.

One general drawback of disclosed slot-and-screw methods is that the positional tension on the pickup is dependent on the amount of compression on the springs-which will vary based on the desired vertical position of the pickup, as adjusted by the player, by turning either of the vertical screws through the threaded hole in the respective end of the pickup. Where a pickup is attached via a screw and spring through a screw hole in a mounting ring or pickguard (i.e., the conventional method) rather than through a slot, the change in tension imposed by the spring on the pickup, as a result of the player changing the vertical position of the pickup, is functionally a non-issue. In slot-and-screw methods for adjusting a pickup linearly or radially, however, changing the pickup's vertical position affects the pickup's linear and radial positional tension-possibly adversely.

Liebchen discloses a slot-and-screw device whereby a pickup is first attached to a base plate (not unlike a carriage of track-and-carriage methods) longer than the pickup and disposed within a pickup cavity of the instrument body, necessitating that the pickup cavity be substantially wider than the length of the pickup.

Baker discloses a plethora of plates and clips and spacers and adapters and fasteners to facilitate linear and radial movement of a pickup. Such methods necessitate substantial space above and below a top of an instrument body, e.g., in a hollowbody instrument (as Baker claims), or substantially customized cavities formed in a solid body instrument. Moreover, such a plurality of intermediate members disposed between the pickup and the track complicate setting and positioning the pickup and thereby inconvenience the player. In these configurations, multiple fasteners must all be tensioned precisely to facilitate independent linear or radial positioning of the pickup. Further, the coupling members may be prone to vibration as well as invite unwanted vibration of the pickup itself.

Moreover, a lack of smooth positioning of a pickup are drawbacks of slot-and-screw methods in general. When a player attempts to push or pull the pickup linearly or radially on-the-fly, the relatively small contact area of the heads of the vertical screws that couple the pickup and horizontal tracks, with or without washers, will cause an undue drag. Swift repositioning by hand will leverage the head and shaft of the vertical screws at an angle against the horizontal tracks, causing uneven forces and frictions that work against smooth and accurate repositioning of the pickup.

All known track-and-carriage methods and all known slot-and-screw methods entail attaching at least one track directly to a top surface or a surface of a cavity of the instrument body. Fitting such a track to a conventional, off-the-rack instrument necessitates drilling holes or (as claimed by Liebchen) applying glue to the body of the instrument. Instrument owners typically have an aversion to such invasive modifications, which will diminish the resale value of the instrument-especially vintage instruments, as buyers seek these in original condition.

In summary, all relevant known art suffers from myriad disadvantages relating to the disclosed stringed instruments or the respective pickup mounting and positioning devices:
(a) Some disclosures posit a stringed instrument custom-configured around said devices rather than said devices configured for fitment in conventional, off-the-rack instruments having a universal pickup cavity.
(b) Some devices require direct attachment to the instrument body and thereby necessitate the removal of existing body material (e.g., by routing or drilling) or the addition of material to the body (e.g., by screwing or gluing), given the typical body dimensions of off-the-rack instruments.
(c) Some devices require clearance from the instrument body, necessitating the removal of body material (e.g., a recess, relief, channel or slot), given the typical body dimensions of off-the-rack instruments.
(d) Some devices do not provide radial adjustment of an attached pickup.
(e) Some devices do not provide positional tension adjustment of an attached pickup.
(f) Some devices will have a side effect of changing linear positional tension of a pickup as a user adjusts the pickup for vertical position, due to compression changes of a dependent spring utilized for the two different functions.
(g) Some devices necessitate an unconventional pickup (e.g., low-profile) or a modified pickup (e.g., mounting legs removed, or additional base plate attached).
(h) Some devices are of substantial weight and displacement, adding unfavorably to the overall body size and weight of the stringed instrument.
(i) Some devices are relatively complicated, comprising parts that require tight tolerances to prevent unfavorable vibration of the parts or the pickups.
(j) Some devices provide vertical pickup mounting screws that drag along horizontal tracks, thereby inhibiting smooth movement of the hanging pickup and restrict the range of usable positional tension adjustment.

### BRIEF DESCRIPTION OF THE DRAWINGS

FIGS. 1 to 5 show views according to a first embodiment of a guitar having a combination of multiple pickups, multiple tracks, and multiple predetermined modes of freedom and restriction of movement of each pickup within two cutouts in a pickguard.

FIG. 1 is a plan view of the first embodiment, wherein a neck pickup and middle pickup are adjustable linearly and radially along opposing tracks, and a bridge pickup is fixed linearly on its bass end and adjustable radially via a track on its treble end.

FIG. 2 is a first cross-section view of the first embodiment, showing a section of the opposing tracks coupled with the ends of the middle pickup.

FIG. 3 is a second cross-section view of the first embodiment, showing a section of the shorter track coupled with the treble end of the bridge pickup and a mounting fastener supporting the bass end of the bridge pickup.

FIG. 4 is a third cross-section view of the first embodiment, showing the end, rather than a middle section, of the shorter track coupled with the treble end of the bridge pickup.

FIG. 5 is an exploded view of the first embodiment, showing the assembly in essentially three planes exploded vertically-pickguard, pickups and tracks, and guitar body, wherein the middle plane shows the assembly of pickups and tracks exploded horizontally.

FIGS. 6 to 8 show views according to a second embodiment of a guitar having one pickup and opposing tracks mounted to a mounting ring.

FIG. 6 is a plan view of the second embodiment, wherein one pickup is adjustable linearly and radially along opposing tracks that span nearly the full distance between the bridge and the end of the neck of the guitar.

FIG. 7 is a cross-section view of the second embodiment, showing a section of the opposing tracks coupled with the ends of the pickup.

FIG. 8 is an exploded view of the second embodiment, showing the assembly in essentially three planes exploded vertically-mounting ring, pickup and tracks, and guitar body, wherein the middle plane shows the assembly of the pickup and tracks exploded horizontally.

### DETAILED DESCRIPTION

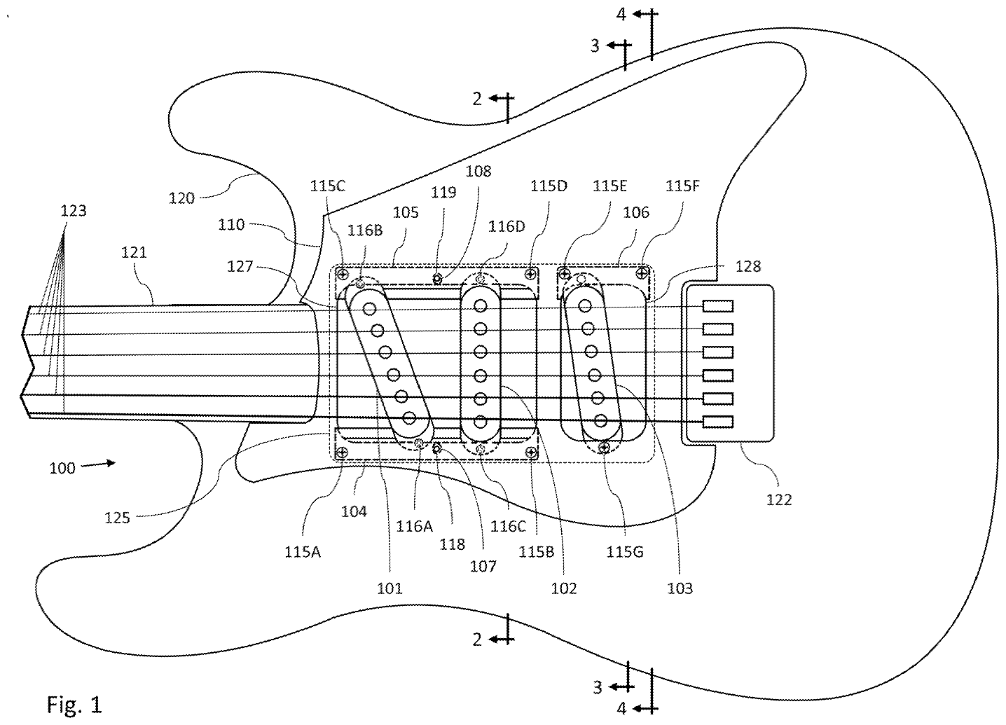

### FIGS. 1 to 5—First Embodiment

FIG. 1 shows a plan view of an assembled guitar 100, including a solid body 120, a neck 121, a bridge 122, and a set of strings 123. A bass-side track 104 and an opposing, treble-side track 105 are mounted to a mounting member depicted as a pickguard 110 via fasteners 115A, 115B, 115C, and 115D. Tracks 104 and 105 are disposed beneath pickguard 110 and within a body cavity 125. A single-coil-sized pickup 101 and a single-coil-sized pickup 102 are coupled at each end to tracks 104 and 105 and are disposed end-to-end within the body cavity 125 and extend vertically through a pickguard cutout 127. Pickups 101 and 102 are further coupled and tensioned to tracks 104 and 105 by setscrews 116A, 116B, 116C, and 116D. A top access hole 107 in pickguard 110 is aligned vertically with a setscrew access hole 118 in track 104, thereby facilitating manual adjustment of setscrew 116A or 116C when the bass end of pickup 101 or 102 respectively is positioned directly in line with hole 107. A top access hole 108 in pickguard 110 is aligned vertically with a setscrew access hole 119 in track 105, thereby facilitating manual adjustment of setscrew 116B or 116D when the treble end of pickup 101 or 102 respectively is positioned directly in line with hole 108. Thusly, setscrews 116A to 116D may be adjusted by inserting a standard Allen key, not shown, through holes 107 and 118, or holes 108 and 119. Setscrews 116A to 116D are envisioned as having a flat tip and made of a nylon material, but other tips such as round, or materials such as steel, may be utilized. To prevent loosening of setscrews 116A to 116D, a low-strength, adjustable threadlocker (not shown) may be applied.

FIG. 1 further shows a shorter treble-side track 106 similarly mounted to pickguard 110, via fasteners 115E and 115F. A single-coil-sized pickup 103 is coupled at the treble end to track 106. The bass end of pickup 103 is mounted to pickguard 110 via a fastener 115G. Pickup 103 is disposed end-to-end within body cavity 125 and extends vertically through a pickguard cutout 128.

From a top view of guitar 100, as shown in FIG. 1, tracks 104, 105, and 106 are substantially hidden under pickguard 110. Pickguard 110 is fastened to body 120 by conventional means—for example, screws or adhesive, not shown.

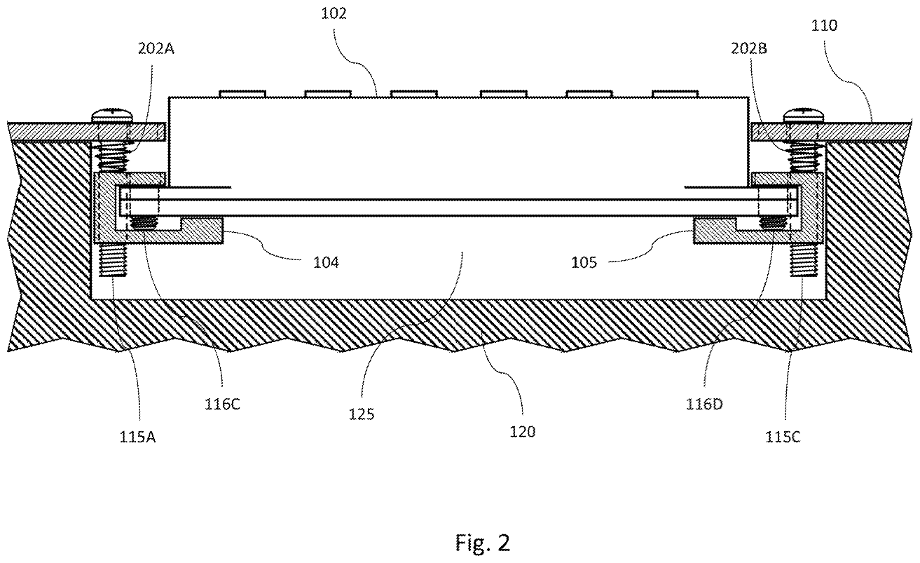

FIG. 2 shows a cross-section revealing detail of the coupling of pickup 102 with tracks 104 and 105. The bass end and treble end of pickup 102 are each trapped between top and bottom portions of tracks 104 and 105 respectively. Track 104 is attached to and supported by fastener 115A through pickguard 110 and a fastener depicted as a spring 202A. Track 105 is attached and supported by fastener 115C through pickguard 110 and a fastener depicted as a spring 202B. Springs 202A and 202B stabilize pickup 102 by applying downward force on tracks 104 and 105 respectively.

The configuration in FIG. 2 represents a conventional single-coil-sized pickup—for example, pickup 102, sized approximately 84 millimeters end-to-end and disposed within a conventional body cavity—for example, cavity 125, being approximately 90 millimeters wide. Since pickup 102 is perpendicular to tracks 104 and 105 and string set 123 (as shown in FIG. 1), each end of pickup 102 has approximately one millimeter of clearance to the approximately two-millimeter-wide vertical portion of tracks 104 and 105.

Additionally in the configuration shown in FIG. 2, the bottom portion of tracks 104 and 105 is sized to give setscrews 116C and 116D each approximately three or four millimeters of horizontal clearance from the upward lip of the bottom portion of tracks 104 and 105 respectively, thereby allowing about 20 degrees of radial positioning of pickup 102 in either direction—i.e., forward or reverse slanting-relative to its current perpendicular, or non-slanted, position. Pickup 101 (FIG. 1), configured in the same manner, illustrates such a 20-degree radial position in a reverse slant.

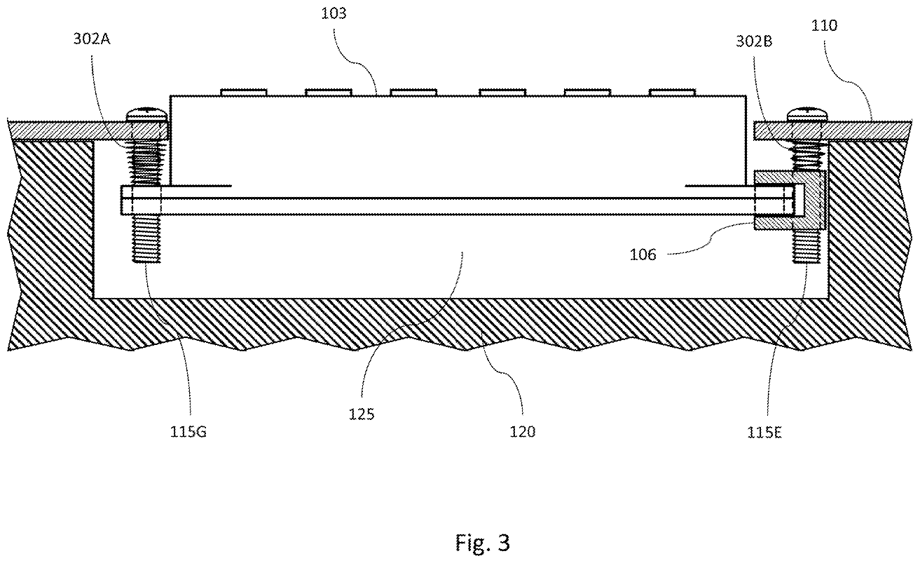

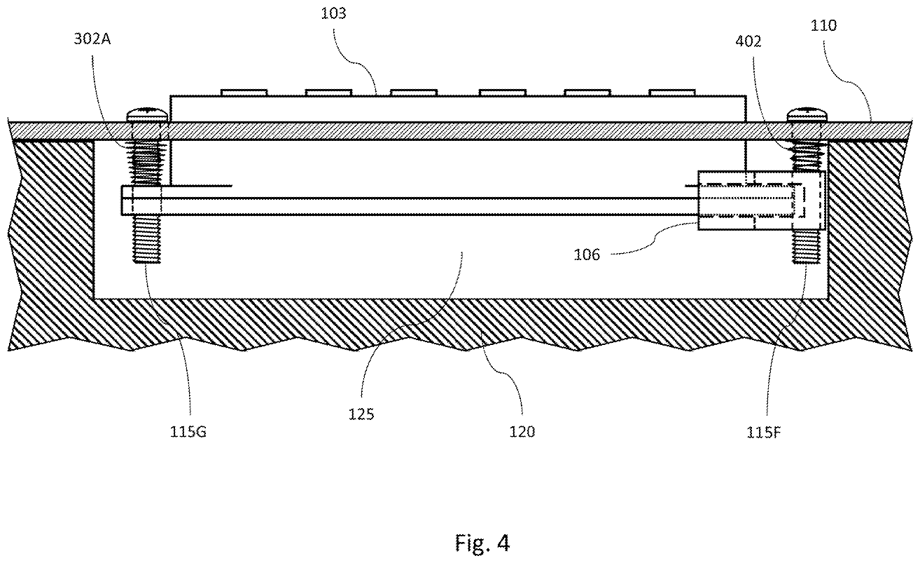

FIGS. 3 and 4 show a cross-section revealing detail of the coupling of pickup 103 with track 106. The bass end of pickup 103 is attached to and supported by fastener 115G through pickguard 110 and a fastener depicted as a spring 302A in a conventional, linearly fixed position in the center of the width of pickguard cutout 128 (FIG. 1). The treble end of pickup 103 is trapped between top and bottom portions of track 106. Track 106 is attached to and supported by fastener 115E (FIG. 3) through pickguard 110 and a fastener depicted as a spring 302B (FIG. 3), fastener 115F (FIG. 4) through pickguard 110 and a fastener depicted as a spring 402 (FIG. 4). Springs 302B (FIG. 3) and 402 (FIG. 4) stabilize pickup 102 by applying downward force on track 106. Thusly, pickup 103 may pivot radially relative to fastener 115G as the pivot point. Track 106, due to its shorter length of approximately 38 millimeters, maintains coupling with pickup 103 through approximately 8 degrees of travel of the treble end of pickup 103 in either direction—i.e., 8 degrees each of forward or reverse slanting—at which point the treble end of pickup 103 abuts a respective end of track 106 as well as a respective side of cutout 128, in this configuration. In other envisioned configurations (not shown), a length of a track and a width of a corresponding pickguard cutout may not be sized equally.

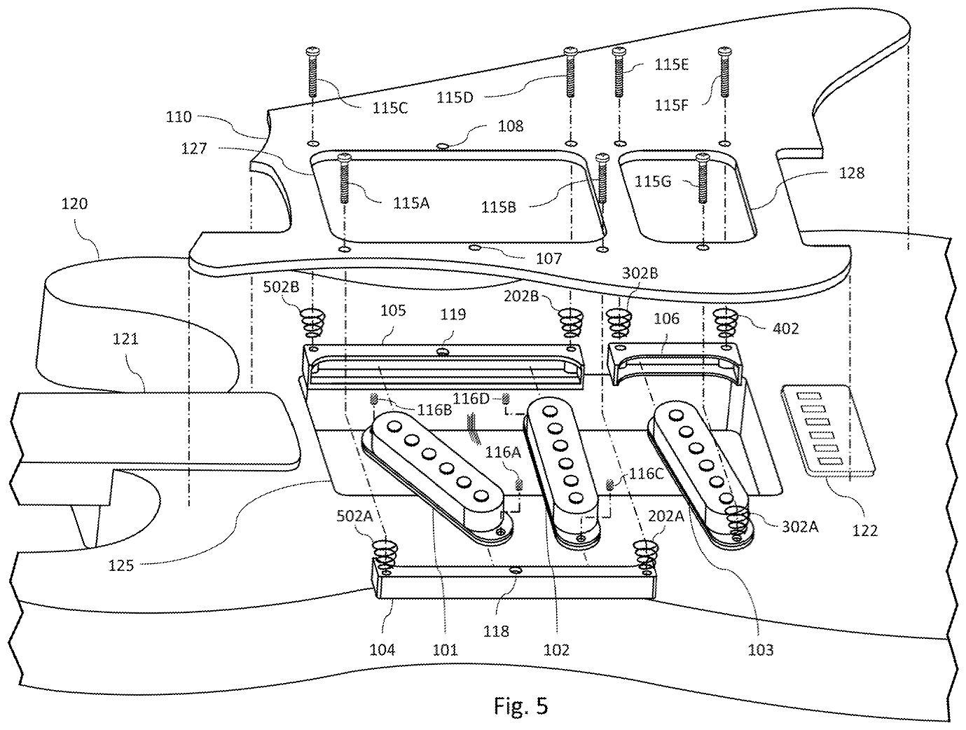

FIG. 5 is an exploded view of the first embodiment, showing essentially three disassembled planes vertically, wherein the middle plane shows pickups 101 to 103 and tracks 104 to 106 disassembled horizontally.

When the embodiment of FIG. 5 is in assembled form, track 104 is attached to and supported by fastener 115A through pickguard 110 and a fastener depicted as a spring 502A. Track 105 is attached to and supported by fastener 115C through pickguard 110 and fastener depicted as a spring 502B. Springs 502A and 502B stabilize pickups 101 and 102 by applying downward force on tracks 104 and 105.

The first embodiment, shown in FIGS. 1 to 5, illustrates one multi-configuration comprising several configurable aspects, any one or multiples of which may be expanded or restricted, in dimensions or in quantity, independently or interdependently, within the inventive scope disclosed herein. For example: the material, number, and size of tracks, the number of pickups coupled to a track, the type of pickups, the number of pickguard cutouts, the size of pickguard cutouts, and the radial positioning of the pickups may be predetermined according to the type of stringed instrument or the preferences of the player.

The material of tracks 104 to 106 embodied in FIGS. 1 to 5 is envisioned as a hard plastic. But other materials, such as steel or aluminum, may be utilized according to, for example, a desired strength and rigidity, given the length of each track 104 to 106. By the same token, track wall thickness may be sized differently than the approximately 1- to 2-millimeter thickness depicted in the embodiments herein. Additionally, fasteners 202A, 202B, 502A, 502B, 302A, 302B and 402, herein depicted as springs, may be of other types and materials—for example, rubber tubing.

### FIGS. 1 to 5—Operation

In this first embodiment, FIGS. 1 to 5 illustrate pickups 101, 102, and 103 moved into their respective positions-vertically, horizontally, radially, and with positional tension-readily by the player according to the player's immediate tone-quality preferences. More basically, this embodiment may reflect a predetermined, delimited configuration based on the player's known tone-quality preference range. For example:
(a) The short-travel treble end of pickup 103 coupled to its own track 106 allows the user to move pickup 103 by hand, on-the-fly, between two preferred slanted positions, one at each end of track 106, while still affording the user the option to finely adjust pickup 103 within a preferred usable range.
(b) Having track 106 dedicated to pickup 103 allows the user to set a vertical position of pickup 103, via fasteners 115E and 115F on the treble end (or plain end—i.e., not requiring a mounting hole) and fastener 115G on the bass end (or tapped end—i.e., having a mounting hole) independently of the vertical positions of pickups 101 and 102.
(c) Tracks 104 and 105 are sized and disposed such that: when the user moves pickup 102 to one end of tracks 104 and 105 by hand, toward the bridge 122, pickup 102 is in a conventional middle-pickup position; and when the user moves pickup 101 to the other end of tracks 104 and 105 by hand, toward the neck 121, pickup 101 is in a conventional neck-pickup position.
(d) Coupling both pickups 101 and 102 to tracks 104 and 105 allows the user to, for instance, set pickup 101 at a predetermined position by tensioning setscrews 116A and 116B, and set pickup 102 by un-tensioning setscrews 116C and 116D-thereby allowing the user to easily slide pickup 102 through a range from abutting pickup 101, in its securely tensioned position, to displaced from pickup 101 and abutting the end of tracks 104 and 105, toward the bridge 122.
(e) Additionally, coupling both pickups 101 and 102 to tracks 104 and 105 allows the user to, for instance, tension and position pickups 101 and 102 abuttedly. With pickups 101 and 102 abutted thusly and engaged concurrently in series wiring via an electronic switch, not shown, the user can achieve the thicker and hum-cancelled sound of a double-coil pickup in any preferred position along tracks 104 and 105.

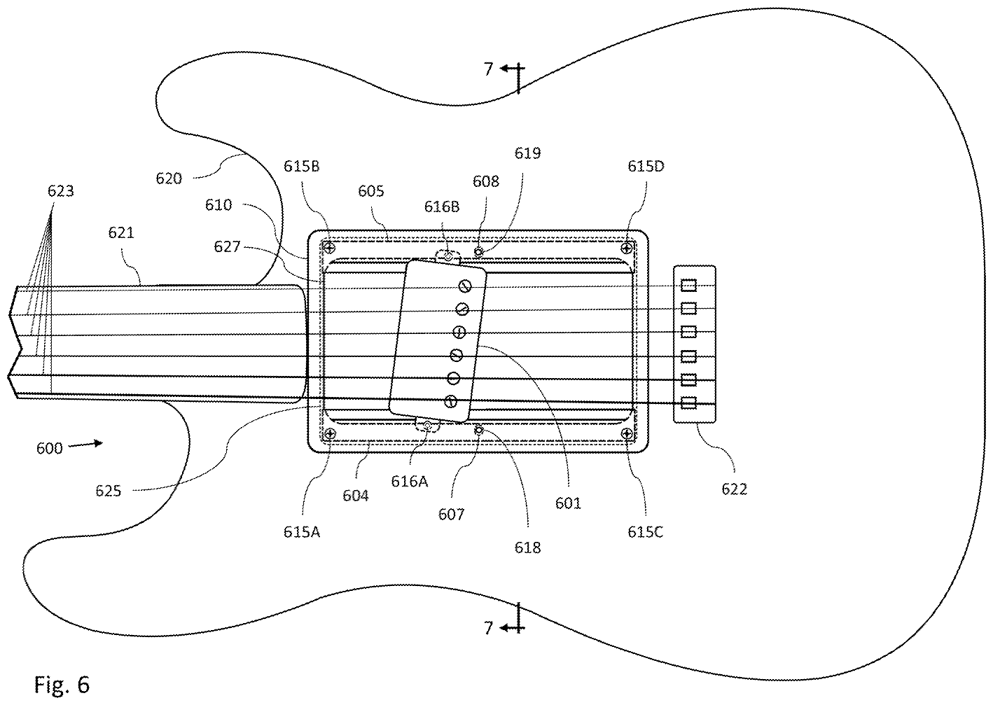

### FIGS. 6 to 8—Second Embodiment

FIG. 6 shows a plan view of an assembled guitar 600, including a solid body 620, a neck 621, a bridge 622, and a set of strings 623. A bass-side track 604 and an opposing, treble-side track 605 are mounted to a mounting member depicted as a mounting ring 610 via fasteners 615A, 615B, 615C, and 615D. Tracks 604 and 605 are disposed beneath mounting ring 610 and within a body cavity 625. A double-coil-sized pickup 601 is coupled at each end to tracks 604 and 605, is disposed end-to-end within a body cavity 625, and extends vertically through a pickguard cutout 627. Pickup 601 is further coupled and tensioned to tracks 604 and 605 by setscrews 616A and 616B. A top access hole 618 in mounting ring 610 is aligned vertically with a setscrew access hole 607 in track 604, thereby facilitating manual adjustment of setscrew 616A when the bass end of pickup 601 is positioned directly in line with hole 618. A top access hole 619 in mounting ring 610 is aligned vertically with a setscrew access hole 608 in track 605, thereby facilitating manual adjustment of setscrew 616B when the treble end of pickup 601 is positioned directly in line with hole 619. Thusly, setscrew 616A may be adjusted by inserting a standard Allen key, not shown, through holes 618 and 607, and setscrew 616B may be adjusted by inserting the Allen key through holes 619 and 608. Setscrews 616A and 616B are envisioned as having a flat tip and made of a nylon material, but other tips such as round, or materials such as steel, may be utilized. To prevent loosening of setscrews 616A and 616B, a low-strength, adjustable threadlocker (not shown) may be applied.

From a top view of guitar 600, as shown in FIG. 6, tracks 604 and 605 are substantially hidden under mounting ring 610. Mounting ring 610 is fastened to body 620 by conventional means—for example, screws or adhesive, not shown.

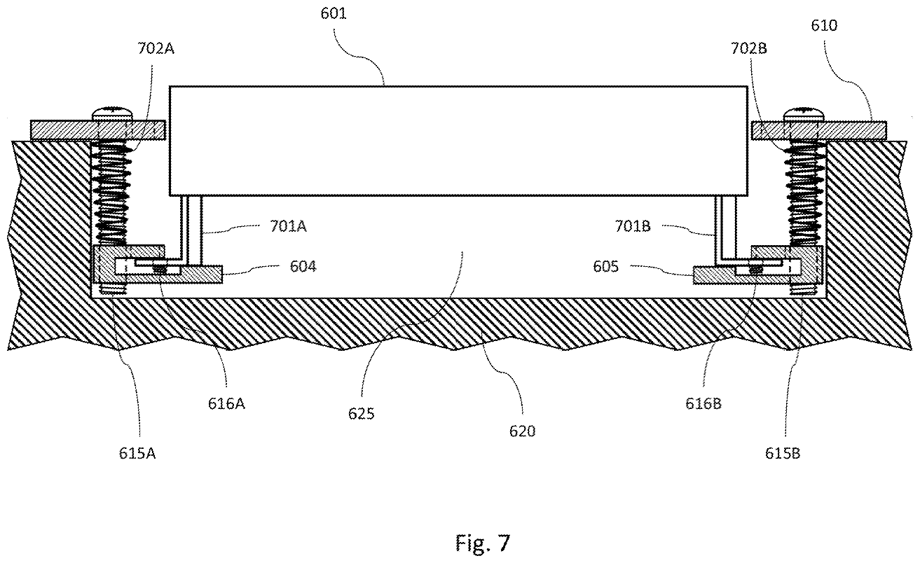

FIG. 7 shows a cross-section revealing detail of the coupling of pickup 601 with tracks 604 and 605. A horizontal portion of a pickup mounting leg 701A and a horizontal portion of a pickup mounting leg 701B are sandwiched between top and bottom portions of tracks 604 and 605 respectively. Track 604 is attached to and supported by fastener 615A through mounting ring 610 and a fastener depicted as a spring 702A. Track 605 is attached and supported by fastener 615B through mounting ring 610 and a fastener depicted as a spring 702B. Springs 702A and 702B stabilize pickup 601 by applying downward force on tracks 604 and 605 respectively. The bottom portion of tracks 604 and 605 is sized to give setscrews 616A and 616B each approximately three millimeters of horizontal clearance from the upward lip of the bottom portion of tracks 604 and 605 respectively, thereby allowing about 20 degrees of radial positioning of pickup 601 in either direction—i.e., forward or reverse slanting-relative to a position perpendicular to tracks 604 and 605 as well as perpendicular to strings 623. As shown in FIGS. 6 to 8, pickup 601 illustrates approximately an 8-degree forward slant.

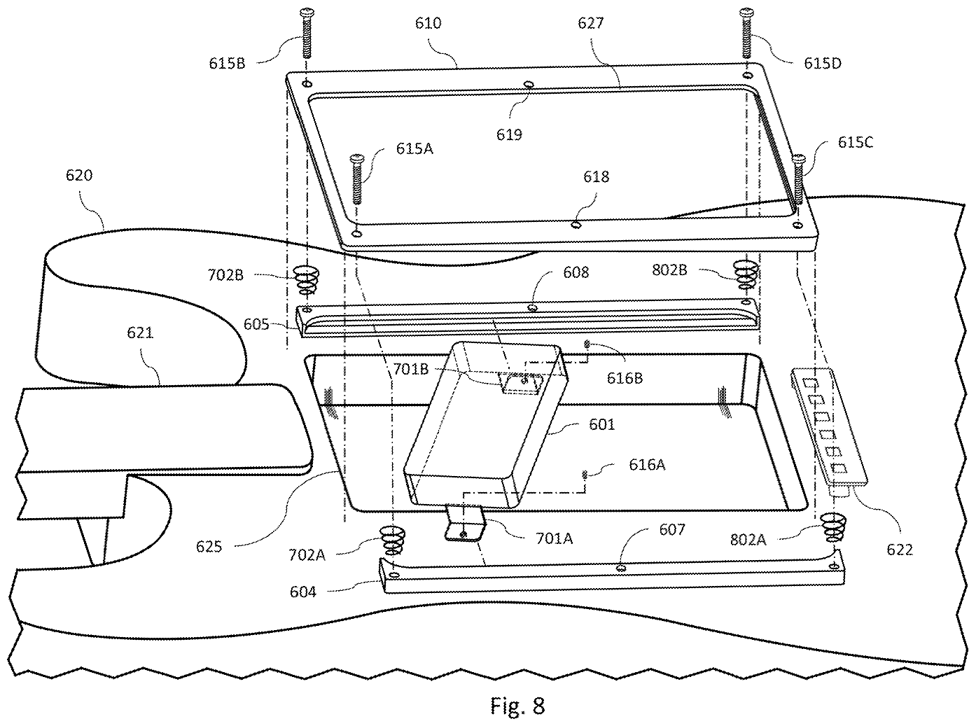

FIG. 8 is an exploded view of the second embodiment, showing essentially three disassembled planes vertically, wherein the middle plane shows pickup 601, track 604, and track 605 disassembled horizontally. Neck 621 has a back angle of a few degrees, typical of instruments with a type of tall bridge 622. Mounting ring 610 is accordingly sized to increase in height toward bridge 622 by approximately 4 millimeters. Shown in FIG. 8 but not shown in FIGS. 6 and 7: a fastener depicted as a spring 802A and a fastener depicted as a spring 802B are configured for tracks 604 and 605 similarly as springs 702A and 702B described above.

The configuration in FIGS. 6 to 8 represents a conventional double-coil-sized pickup—for example, pickup 601—sized approximately 84 millimeters end-to-end, including legs 701A and 701B, and disposed within a conventional body cavity—for example, cavity 625, sized approximately 90 millimeters wide and approximately 19 millimeters deep. Even with legs 701A and 701B conventionally sized approximately 8 millimeters vertically and disposed from the bottom of the body of pickup 601, as shown, the low profile of tracks 604 and 605—approximately 5 millimeters in height-allow for ample vertical positioning of pickup 601 within cavity 625.

The material of tracks 604 and 605 embodied in FIGS. 6 to 8 is envisioned as a hard plastic. But other materials, such as steel or aluminum, may be utilized according to, for example, a desired strength and rigidity, given the length of tracks 604 and 605. By the same token, track wall thickness may be sized differently than the approximately 1- to 2-millimeter thickness depicted in the embodiments herein. Additionally, fasteners 702A, 702B, 802A, and 802B, herein depicted as springs, may be of other types and materials—for example, rubber tubing.

### FIGS. 6 to 8—Operation

Tracks 604 and 605 may be equally pitched via fasteners 615A to 615D, whereby a constant vertical distance between pickup 601 and strings 623 (FIG. 6) is maintained as the user moves pickup 601 to any position along tracks 604 and 605.

Further, tracks 604 and 605 may be pitched via fasteners 615A to 615D such that the vertical distance between pickup 601 and strings 623 (FIG. 6) increases or decreases as the user moves pickup 601 along tracks 604 and 605—for example, to increase the distance between pickup 601 and strings 623 (FIG. 6) as the user moves pickup 601 towards neck 621, thereby allowing the user to equalize signal output.

Moreover, tracks 604 and 605 may be vertically adjusted independently of each other via fasteners 615A to 615D, whereby the bass end of pickup 601 and the treble end of pickup 601 are each a different vertical distance from strings 623 (FIG. 6)—for example, to emphasize or de-emphasize bass or treble frequency output as preferred by the user.

### CONCLUSION

From the example embodiments above, a number of advantages become evident:
(a) The direct coupling of a pickup to the low-profile track provides a universal-fit approach, noninvasive installation, and compatibility with conventional pickup types and universal body cavities-unlike prior art requiring retrofit modifications or custom builds.
(b) Installation is easily reversed, with the instrument returned to its original configuration.
(c) The lightweight track and lack of intermediary elements (e.g., carriages or base plates) result in no discernable added weight to the instrument.
(d) Top access to setscrews allows the user to easily set a sliding friction of each pickup for ease of movement or lack thereof, in various playing scenarios such as stage vs. studio, or on-the-fly sliding of multiple pickups together or apart at predetermined positions.

The description above should not be construed as limiting the scope of the embodiments but as merely providing illustrations that persons skilled in the art will appreciate. One may readily envision other embodiments for guitars, basses, and other electric and acoustic stringed instruments having pickups. Thus the scope of embodiments should be determined by the appended claims and their legal equivalents rather than by the examples given.

I claim as my invention:

1. A device for adjustably mounting at least one pickup in a stringed instrument, the device comprising:
(a) at least one track having a top portion and a bottom portion vertically disposed and thusly trapping at least one end of the at least one pickup, thereby directly and adjustably coupling the at least one pickup to the at least one track;
(b) a mounting member attached to a body of the stringed instrument;
(c) the at least one track attached to the mounting member such that the at least one pickup is proximate to a plurality of strings of the stringed instrument;
whereby a player may position the at least one pickup linearly and radially along a length of the at least one track for tonal variations as desired.

2. The device of claim 1, wherein the at least one track is sized in length such that when the at least one pickup is positioned at a predetermined maximum radial angle, the at least one pickup remains coupled to the at least one track.

3. The device of claim 1, further comprising at least one track fastener adjustably attaching the at least one track to the mounting member, whereby a player may position the at least one pickup a first vertical distance from the plurality of strings.

4. The device of claim 1, wherein:
(a) the device further comprises at least one pickup fastener;
(b) the at least one end of the at least one pickup comprises a plain end and a tapped end disposed oppositely;
(c) the plain end is coupled to the at least one track;
(d) the at least one pickup fastener adjustably attaches the at least one pickup to the mounting member through the tapped end;
whereby a player may adjust the tapped end of the at least one pickup a second vertical distance from the plurality of strings.

5. The device of claim 1, wherein the at least one track comprises at least one pair of opposing tracks, whereby the at least one pickup is adjustably coupled about perpendicularly between the at least one pair of opposing tracks.

6. The device of claim 1, further comprising at least one setscrew disposed through the at least one end of the at least one pickup and exerting force on an inner surface of the bottom portion of the at least one track, thereby setting a friction level during positioning of the at least one pickup and securing a current position of the at least one pickup.

7. The device of claim 6, further comprising:
(a) at least one setscrew access hole disposed through the top portion of the at least one track;
(b) at least one top access hole disposed through the mounting member in alignment with the at least one setscrew access hole;
whereby positioning the at least one end of the at least one pickup in line with the at least one top access hole facilitates access to the at least one setscrew, thereby allowing insertion of a tool for manual adjustment of the at least one setscrew as desired by the player.

8. The device of claim 1, wherein the bottom portion of the at least one track includes an upward lip sized and disposed sufficiently such that when the at least one setscrew abuts the upward lip, the at least one end of the at least one pickup is thusly trapped horizontally within the at least one track, thereby maintaining the direct coupling of the at least one pickup to the at least one track and delimiting the radial movement of the at least one pickup during positioning of the at least one pickup by the player.

9. The device of claim 1, wherein the mounting member is a pickguard.

10. The device of claim 1, wherein the mounting member is a mounting ring.

11. The device of claim 1, wherein the mounting member comprises at least one pickup cutout sized in width such that when the at least one pickup is positioned at a predetermined maximum radial angle, the at least one pickup remains coupled to the at least one track.

12. The device of claim 1, wherein the at least one track is sized and disposed within a length, a width, and a depth of at least one pickup cavity of the stringed instrument.

13. The device of claim 1, wherein the at least one track comprises a plurality of tracks disposed end-to-end.

14. The device of claim 1, wherein the at least one pickup is in the form of a typical single-coil-sized pickup.

15. The device of claim 1, wherein the at least one pickup is in the form of a typical double-coil-sized pickup having at least one mounting leg.
